(19) United States
(12) Patent Application Publication
(10) Pub. No.: US 2007/0201880 A1
(43) Pub. Date: Aug. 30, 2007

(54) High power amplifiers

(76) Inventor: Jeffrey Nicholson, Chatham, NJ (US)

Correspondence Address: Law Firm of Peter V.D. Wilde, 301 East Landing, Williamsburg, VA, 23185, US

(21) Appl. No.: 11/362,973

(22) Filed: Feb. 27, 2006

(51) Int. Cl. H04B 10/04; H04B 10/12

(52) U.S. Cl. 398/188

(57) ABSTRACT

The specification describes an improved seed laser source for high power MOPA applications. Improvement is obtained by modulating the seed laser with a broadband noise function, for example, a Guassian noise function. A broadband noise function is one in which, in contrast to a sine wave function for example, has an RF spectrum with a bandwidth comparable in value to the mean frequency. Use of a broadband noise modulator allows effective tuning of the output of the modulated laser.

### FIELD OF THE INVENTION

This invention relates to high power amplifiers and more specifically to master oscillator power amplifiers (MOPA).

### BACKGROUND OF THE INVENTION

High power fiber amplifiers frequently make use of low power seed lasers in master oscillator power amplifier (MOPA) configurations. The difficulty is that these seed lasers often have very narrow linewidths, meaning nonlinearities in the fiber amplifier due to stimulated Brilluoun scattering (SBS) limit the output power. This is a problem that is also often faced in long haul communication systems. One frequently employed solution uses phase modulation to broaden the linewidth of the seed laser, and raise the threshold for SBS. In communication systems however, the amount of broadening required, in comparison to the modulation rate of high-speed systems, is very small. Consequently, phase modulation using a few discrete sinusoidal tones is sufficient to generate the desired SBS suppression.

In contrast, in applications using high power lasers such as ranging, LIDAR, or remote spectroscopy, the shape of the spectrum of the seed laser, or equivalently, its coherence function, is an important concern. In such applications, simply generating discrete sidebands may not be sufficient, largely because the sine wave sidebands are not smooth in amplitude. Moreover, the ability to tune the spectral width over a wide range would be a desirable feature. As power levels rise, non-linear effects become an issue. Non-linear effects are addressed in U.S. Pat. No. 5,200,964 which proposes modulating the source laser with a broadband noise signal.

### SUMMARY OF THE INVENTION

Recognizing that conventional approaches for broadening the spectrum of seed lasers for state of the art MOPA-type devices have limited effectiveness due in part to the narrow bandwidth of the seed laser, an improved seed laser source for high power MOPA applications that has a much improved spectrum has been developed. Improvement is obtained by modulating the seed laser with a broadband noise function, for example, a Guassian noise function. A broadband noise function is one in which, in contrast to a sine wave function for example, has an RF spectrum with a bandwidth comparable in value to the mean frequency. With this modulating mechanism, the power can be varied using simple and cost effective means. “MOPA-type” devices are designated as those that use a combination of a laser/amplifier to produce a high power light output

### BRIEF DESCRIPTION OF THE DRAWING

FIG. 1 is a schematic representation of a sample arrangement used to modulate the seed laser in a MOPA-type device;

FIG. 2 is a calculated spectrum showing the output of the arrangement of FIG. 1;

FIG. 3 is a calculated spectrum, overlaid on the spectrum of FIG. 2, for an arrangement according to the invention where the laser is modulated with a Gaussian noise function;

FIG. 4 is a plot of the calculated width Calculated width of the optical spectrum, normalized to the width of the Gaussian modulation function, as a function of modulation amplitude, normalized to the amplitude of a sine wave that varies from +π to −π.

FIG. 5 is a schematic diagram showing a typical implementation of a broad-band RF noise source using cascaded amplifiers, a low pass filter to select noise bandwidth, driving an electro-optic phase modulator.

FIG. 6 is a plot showing measured RF power spectrum produced from a series of cascaded RF amplifiers with a filter, such as shown in FIG. 5;

FIG. 7 is a measured optical spectrum at the output of the phase modulator as the drive voltage on the first amplifier in the RF chain is varied as indicated; and

FIG. 8 is a schematic diagram showing an RF amplifier chain with a set of low-pass filters with different cut-off frequencies that can be switched in and out of the amplifier chain;

FIG. 9 is a schematic diagram similar to that of FIG. 8 showing one method of varying the RF power to the laser; and

FIG. 10 is an alternative method for varying the power to the laser.

### DETAILED DESCRIPTION

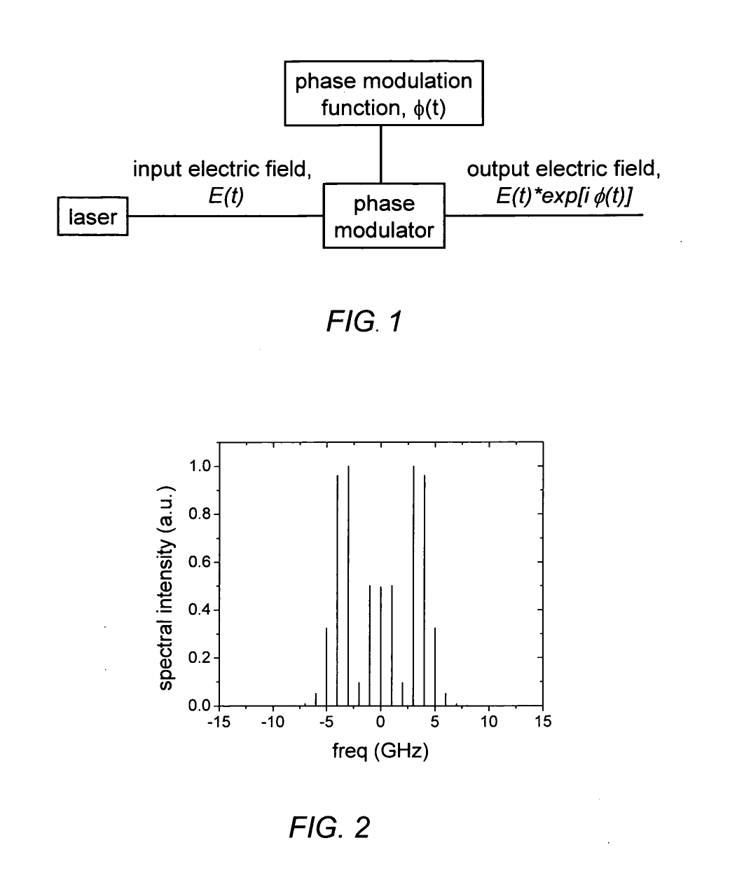

With reference to FIG. 1, a schematic arrangement for a MOPA device is shown. A phase modulator is used to impart a phase φ(t) to the electric field E(t) of the signal laser. The signal laser may be a continuous wave laser but is preferably a pulsed laser or is a laser with a digitally modulated signal. In a typical MOPA device the phase modulation function φ(t) is sinusoidal. The result is that discreet sidebands are imparted to the output spectrum. For example if the input spectrum is very narrow (few MHz) and φ(t) is a sine wave with an amplitude of ±π and a frequency of 1 GHz, then the output spectrum will appear as plotted in FIG. 2. FIG. 2 is plotted with zero frequency at the center laser frequency. Large side bands are generated at approximately ±3-4 GHz, with a separation of 1 GHz. The sidebands do not grow monotonically, but increase and decrease in power depending on the modulation depth (i.e. amplitude of φ(t)). The resulting power curve is non-ideal as a starting spectrum for the amplified laser device.

According to one aspect of the invention, the initial power spectrum for a MOPA device is produced by modulating the laser signal using a broadband noise source. For example, rather than using a pure sine wave for φ(t), a waveform that is Gaussian in shape is used. In this case the φ(t) is normalized such that it's root-mean-square (RMS) deviation is equal to that of a sine wave that varies from +π to −π. This means that the power contained in this randomly varying φ(t) is equal to that of the π sine wave modulation. This condition is imposed for the comparative analysis.

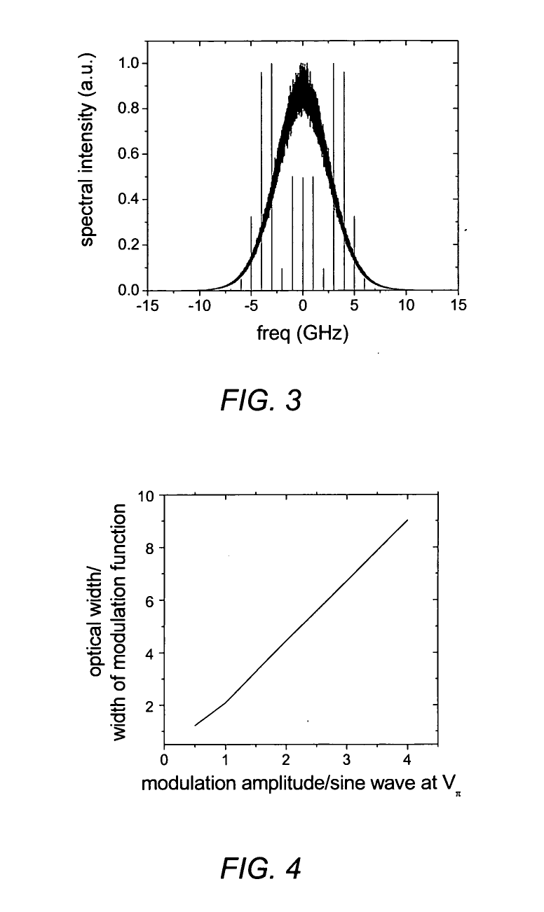

The spectrum that results from Gaussian noise modulation is shown in FIG. 3 as a continuous line. For comparison, the spectrum obtained with sine wave modulation from FIG. 2 is also plotted. Note that the output spectrum of the laser with the Gaussian modulation is 1) also Gaussian, and 2) approximately twice as broad (FWHM) as the modulation function.

Based on these analyses, it is concluded that the desirable MOPA operation according to the invention is using a random noise RF source to modulate the seed laser that has an RF spectrum with bandwidth at least equal to the magnitude of its mean frequency. In a preferred embodiment, the RF bandwidth is at least 1.5 times the mean frequency.

A useful distinction between modulating with a sine wave and modulating with the Gaussian power spectrum is that the laser spectrum remains Gaussian, but its width simply broadens with increasing modulation amplitude. In contrast, as mentioned above, the power in the side bands obtained with sinusoidal modulation can decrease and then increase again, with increasing modulation amplitude.

FIG. 4 shows the width of the optical spectrum, normalized to the width of the Gaussian modulation function, as a function of modulation amplitude, normalized to the amplitude of a ±π sine wave. For modulation amplitudes a little of V_{π}, any residual power at the center laser frequency is suppressed, and the output is a pure Gaussian spectrum that increases linearly with increasing modulation amplitude.

While the Gaussian spectrum a produces the desired outcome, as shown by the analysis above, the spectrum does not need to be Gaussian but may comprise any waveform that has a relatively smooth power envelope with a finite width. The spectrum should be peaked but need not be exactly Gaussian. In the preferred case, significant sidebands in the spectrum are avoided by prescribing a spectrum without inversion points.

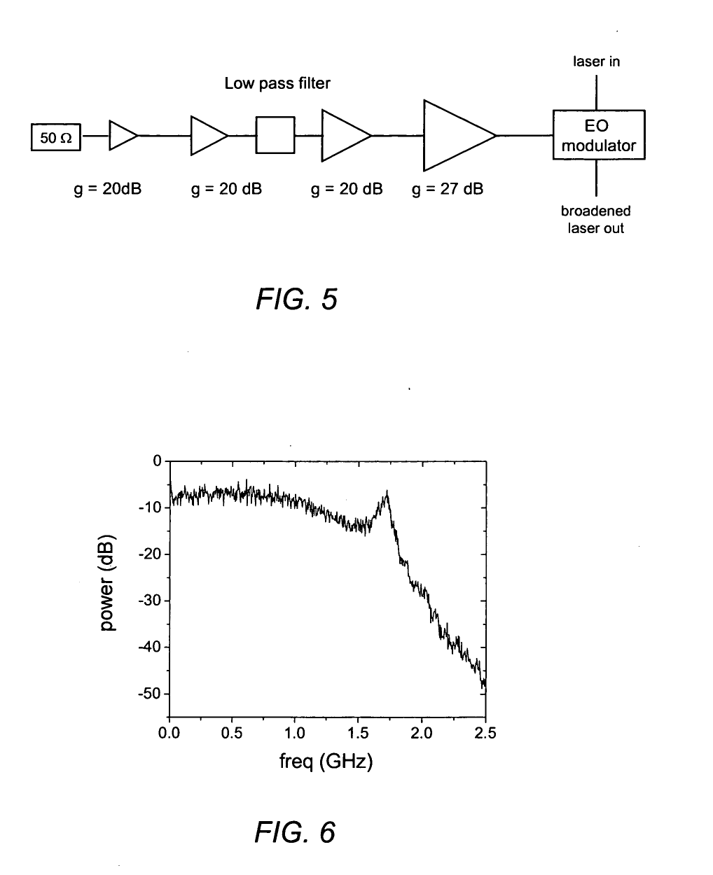

A suitable spectrum, in this case not purely Gaussian, may be produced using cascaded RF amplifiers, and amplifying thermal noise up to powers sufficient to drive a LiNO₃ optical phase modulator. The spectral width is obtained through filtering, both with the gain bandwidth of the chosen RF amplifiers as well as with additional RF low-pass filters. FIG. 5 shows a experimental implementation of such a series of cascaded RF amplifiers driving an electro-optic phase modulator. FIG. 6 shows a typical RF power spectrum that is produced from this series of cascaded amplifiers. The RF spectrum of FIG. 6 has a calculated mean frequency of approximately 0.7 GHz, and a 3 dB bandwidth of approximately 1 GHz.

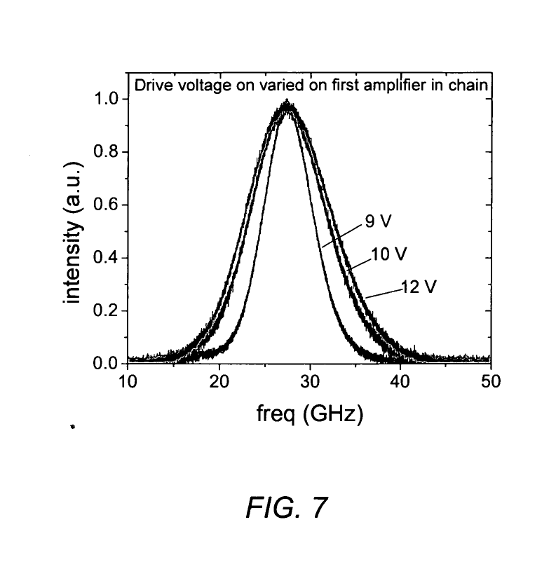

To obtain a variable line width, the RF power to the electro optic modulator can be varied, either by varying the drive current to one of the RF amplifiers, or by adding a variable attenuator to the RF amplifier chain. As an example, the measured output spectrum from the experiment is shown in FIG. 7 as the drive voltage on the first amplifier in the chain in FIG. 5 was varied. The spectrum retains its shape as the voltage to the amplifier was increased. However the linewidth continuously increased with increasing drive voltage. In contrast, with sinusoidal drive voltages, the relative strength of the side bands continuously changes as the modulation depth is increased.

The measured spectra in FIG. 7 show the desired tuning behavior in linewidth versus drive voltage. This approach to generating optical spectral bandwidth has a number of desirable features:
1. The approach is based on broadening low noise seed lasers, which lends itself to MOPA configurations.
2. The output power is essentially independent of linewidth, in contrast to using an optical filter to narrow a broad linewidth source.
3. Depending on the amplifiers used it can operate over a wide range—from a few tens of MHz to potentially hundreds of GHz.
4. It also has been demonstrated at a variety of seed laser wavelengths including 1080 nm and 1550 nm.

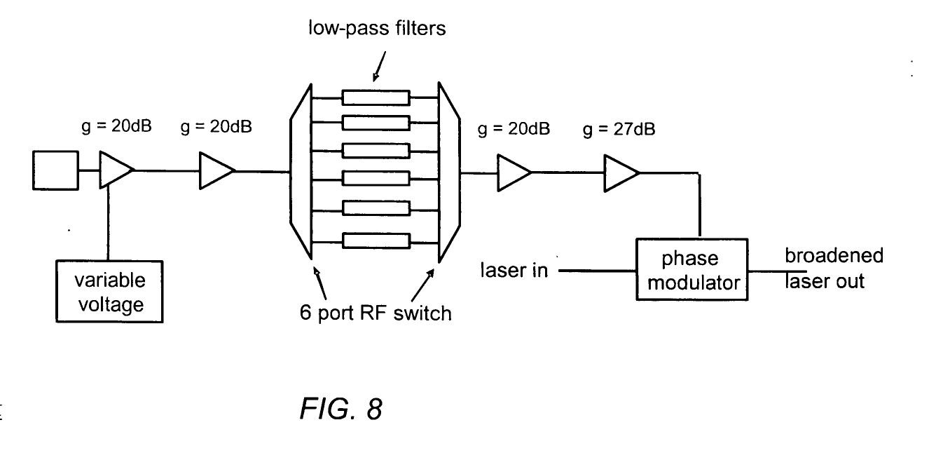

To extend the range of available linewidths, the RF noise source shown in FIG. 5 can be modified. As long as the bandwidth of the gain of the RF amplifiers is broader than the cutoff frequency of the embedded low-pass filter, the bandwidth of the RF noise source, and consequently the linewidth of the broadened optical radiation, is determined by the cut-off frequency of the low pass filter. According to on embodiment of the invention, a low pass filter with a tunable cut-off frequency is used to provide tunable linewidth. This embodiment is theoretically promising, however, tunable low-pass RF filters that operate at high frequency typically have limited tuning ranges, and are expensive. An alternative is to use multiple filters with a range of cut-off frequencies, and switch these filters in and out of the amplifier chain. Broad bandwidth RF switches with multiple ports can be used to accomplish the filter switch with electronic means. The schematic of such a device is shown in FIG. 8, which is capable of generating 6 discrete linewidths determined by the cut-off frequencies of the 6 low-pass filters.

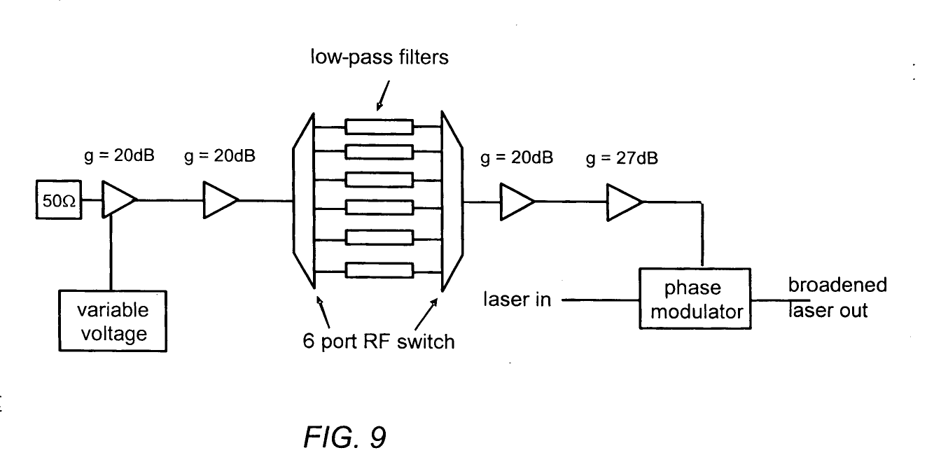

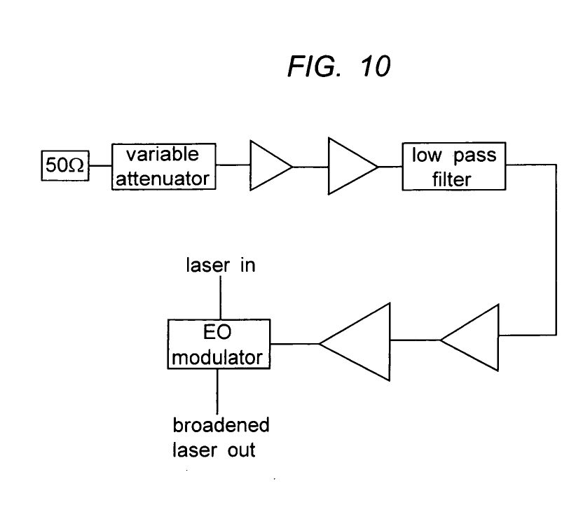

The span of linewidths that can be achieved with the setup shown in FIG. 8 is limited only by the gain bandwidth of the RF amplifiers. Continuous tuning in this arrangement can be created by adding variable drive voltages to one of the RF amplifiers. In the embodiment shown in FIG. 9, the variable drive voltage is shown as applied to the first amplifier stage. However, similar results follow if the variable drive is used at another amplifier stage in the chain. Different filters, if used in the low pass filter bank, allow for large changes in the optical linewidth. The variable voltage drive on one of the RF amplifiers in the chain allows for continuous tuning of the linewidth to span the range between discrete filters.

Another alternative embodiment to achieve a tunable source is to incorporate a variable attenuator in the amplifier chain. This embodiment is shown in FIG. 10, where the variable attenuator is connected at the beginning of the amplifier series. It could also be placed at other locations in the signal path.

The several different approaches to providing a tuning capability to the RF input to the laser all follow the recognition that a broad band noise source, in contrast to conventional laser modulating waveforms, allows continuous tuning over a wide tuning range at a relatively stable amplitude. A phase modulator employing these tuning elements and providing the tuning function described is defined here and below as a tunable phase modulator.

In the devices described above the laser input may be continuous, but preferably is pulsed. The recognition that the broadband phase modulating signal, and the tuning feature of that signal, can be advantageously applied to a digital or pulsed laser input is an important aspect of the invention.

It will be understood by those skilled in the art that the invention described above is advantageously implemented using optical fibers, and optical fiber elements, i.e. amplifiers/filters.

In concluding the detailed description, it should be noted that it will be obvious to those skilled in the art that many variations and modifications may be made to the preferred embodiment without substantial departure from the principles of the present invention. All such variations, modifications and equivalents are intended to be included herein as being within the scope of the present invention, as set forth in the claims.

1. Optical device comprising:
(a) a seed laser,
(b) a tunable phase modulator for modulating the seed laser, the phase modulator having:
(i) a phase modulation function that is a random noise source with an RF power spectrum in which the bandwidth is at least approximately equal to the mean frequency, and
(ii) a variable RF power input to generate an RF power spectrum with a variable linewidth.

2. The device of claim 1 wherein the random noise source has a Gaussian RF power spectrum.

3. The device of claim 1 wherein the RF power spectrum has a bandwidth at least 1.5 times the mean frequency.

4. The device of claim 1 wherein the RF power spectrum is produced using cascaded RF amplifiers.

5. The device of claim 5 wherein the cascaded RF amplifiers comprise at least two amplifier stages of at least one amplifier each, separated by a low pass filter.

6. The device of claim 1 wherein the wavelength of the seed laser is approximately 1550 nm.

7. The device of claim 1 wherein the wavelength of the seed laser is approximately 1080 nm.

8. The device of claim 4 further including a variable voltage source to vary the power to at least one of the amplifiers.

9. The device of claim 4 further including a variable attenuator to vary the signal to at least one of the amplifiers.

10. The device of claim 4 further including at least two filters with a switch for switching the signal between the filters.

11. The device of claim 1 wherein the laser is a pulsed laser.
